(19) United States
(12) Patent Application Publication
(10) Pub. No.: US 2026/0133106 A1
(43) Pub. Date: May 14, 2026

(54) STRUCTURAL FATIGUE LIFE PREDICTION METHOD AND SYSTEM CONSIDERING STRENGTH DEGRADATION EFFECT

(71) Applicant: East China Jiaotong University, Nanchang (CN)

(72) Inventors: Qian Xiao, Nanchang (CN); Xueshan Gao, Nanchang (CN); Xilin Wang, Nanchang (CN); Daoyun Chen, Nanchang (CN); Lin Li, Nanchang (CN); Mingkang Zhang, Nanchang (CN); Yanjie Zhang, Nanchang (CN); Xiaoyi Ma, Nanchang (CN)

(21) Appl. No.: 18/982,314

(22) Filed: Dec. 16, 2024

(30) Foreign Application Priority Data
Nov. 8, 2024 (CN) 2024115918838

(51) Int. Cl. G01N 3/32; G01M 99/00

(52) U.S. Cl. CPC G01N 3/32; G01M 99/007; G01N 2203/0073; G01N 2203/0218; G01N 2203/0688

(57) ABSTRACT

A structural fatigue life prediction method considering strength degradation effect, wherein the method includes: obtaining strain-time data of the structure under at least one working condition; converting the strain-time data into a stress spectrum; processing the stress spectrum by using a nonlinear cumulative damage model considering strength degradation effect to obtain the residual damage of the structure; calculating the fatigue life of the structure according to the residual damage. The invention modifies the nonlinear cumulative damage model by introducing stress ratio and strength degradation coefficient. The function is mainly expressed in exponential form, which can better reflect the degradation performance of the material. The model form is simple and it can be well applied to practical engineering. This model can be applied to the prediction of fatigue life under multi-level load, which greatly improves the prediction accuracy of structural fatigue life.

### TECHNICAL FIELD

The invention relates to the technical field of equipment life prediction, and in particular to a structural fatigue life prediction method and system considering strength degradation effect.

### BACKGROUND ART

With the continuous improvement of industrial technology, modern mechanical equipment is developing towards large-scale, high-speed and high-performance. Fatigue failure, one of the most important failure modes of mechanical equipment, is not only hidden and sudden, but also accounts for 50%-90% of the total failure of mechanical structures.

Studies have shown that most materials exhibit an extremely nonlinear relationship between cumulative damage and cyclic loads. The nonlinear cumulative damage theory takes into account the load interaction and load sequence, but it cannot be directly used in engineering practice due to factors such as overly complex expressions and difficulty in determining the introduced experimental coefficients.

The number of loads and the load level are the dominant factors that determine the fatigue cumulative damage value, and the current damage state and stress state of the structure will also affect the accumulation of fatigue damage. This is because with the continuous application of loads and the continuous accumulation of damage, the bearing capacity of the structure will degrade, that is, the residual strength degradation. The load interaction and residual strength degradation will have an impact on the subsequent cumulative damage, especially in the middle and late stages of the structure's life. With the continuous degradation of the structure's residual strength, the mechanical properties continue to deteriorate, which will accelerate the accumulation of fatigue damage. Considering the impact of residual strength degradation when calculating fatigue cumulative damage is more in line with the actual damage process, which is of great significance to improving the accuracy of fatigue life prediction of engineering structures.

### SUMMARY OF THE INVENTION

The purpose of the invention is to provide a structural fatigue life prediction method and system considering strength degradation effect, thereby greatly improving the accuracy of fatigue life prediction.

To achieve the above object, the invention provides the following solutions:
a structural fatigue life prediction method considering strength degradation effect, wherein the method includes:
obtaining strain-time data of the structure under at least one working condition;
converting the strain-time data into a stress spectrum;
processing the stress spectrum by using a nonlinear cumulative damage model considering strength degradation effect to obtain the residual damage of the structure;
calculating the fatigue life of the structure according to the residual damage.

Alternatively, the method further includes: constructing a nonlinear cumulative damage model considering strength degradation effect, specifically including:
obtaining nonlinear cumulative damage model and strength degradation model considering history loading effect;
introducing a strength degradation coefficient according to the strength degradation model;
updating the nonlinear cumulative damage model by using the load ratio and the strength degradation coefficient to obtain a nonlinear cumulative damage model considering strength degradation effect.

Alternatively, the nonlinear cumulative damage model is:

$${D}_{i} = {( 1 - \frac{{n}_{i}}{{N}_{fi}} )}^{{δ}_{i}} - 1 = {[ {( 1 - \frac{{n}_{i + 1 , i}}{{N}_{f , ( i + 1 )}} )}^{{δ}_{i + 1}} - 1 ]}^{{γ}_{i , i + 1}}$$

wherein Dᵢ is the damage of the structure under the i-th level load; N_{fi} is the fatigue life at the corresponding stress level; nᵢ is the number of cycles under the i-th stress level; δᵢ is the model parameter, which is a model parameter that depends only on N_{f} and the given stress level, δᵢ=−1.25/ln N_{fi}; γ_{i,i+1} the load interaction factor,

$${γ}_{i , i + 1} = \frac{{σ}_{i}}{{σ}_{i + 1}} ;$$

σᵢ is the i-th level stress; n_{i+1,i} is the equivalent cycle number;
the strength degradation model is:

$$R ( n ) = {R}_{0} + ( {R}_{0} - {S}_{f} ) \frac{ln [ 1 - n / ( {N}_{f} + 1 ) ]}{ln ( {N}_{f} + 1 )}$$

wherein R(n) is the residual strength; R₀ is the initial tensile strength; S_{f} is the corresponding stress peak.

Alternatively, the load ratio is combined with the strength degradation coefficient in the form of an exponential function,

$${η}_{i , i + 1} = {( \frac{{σ}_{i}}{{σ}_{i + 1}} )}^{{A}_{k}} ;$$

wherein the strength degradation coefficient is

$${A}_{k} = exp [ \frac{R ( {n}_{i} )}{{R}_{0}} - 1 ] .$$

Alternatively, converting the strain-time data into a stress spectrum specifically includes:
obtaining the strain-time data; the strain-time data is a strain signal collected by a strain gauge;
performing balance adjustment on the strain-time data;
performing digital filtering;
converting the filtered strain signal into a stress signal;
performing zero drift on stress signals;
processing abnormal signals;
calculating the stress signal using the rainflow counting method to obtain a stress spectrum of the strain-time data.

A structural fatigue life prediction system considering strength degradation effect, wherein the system comprises:
a data obtaining unit for obtaining strain-time data of the structure under at least one working condition;
a data conversion unit for converting the strain-time data into a stress spectrum;
a stress spectrum processing unit for processing the stress spectrum by using a nonlinear cumulative damage model considering strength degradation effect to obtain the residual damage of the structure;
a fatigue life calculation unit for calculating the fatigue life of the structure according to the residual damage.

Alternatively, the system further comprises a model building unit, specifically comprising:
a model obtaining subunit for obtaining nonlinear cumulative damage model and strength degradation model considering history loading effect;
a strength degradation coefficient introduction subunit for introducing a strength degradation coefficient according to the strength degradation model;
a model updating subunit for updating the nonlinear cumulative damage model by using the load ratio and the strength degradation coefficient to obtain a nonlinear cumulative damage model considering strength degradation effect.

Alternatively, the nonlinear cumulative damage model is:

$${D}_{i} = {( 1 - \frac{{n}_{i}}{{N}_{fi}} )}^{{δ}_{i}} - 1 = {[ {( 1 - \frac{{n}_{i + 1 , i}}{{N}_{f , ( i + 1 )}} )}^{{δ}_{i + 1}} - 1 ]}^{{γ}_{i , i + 1}}$$

wherein Dᵢ is the damage of the structure under the i-th load level; N_{fi} is the fatigue life at the corresponding stress level; nᵢ is the number of cycles under the i-th stress level; δᵢ is a model parameter that depends only on N_{f} and the given stress level, δᵢ=−1.25/ln N_{fi}; γ_{i,i+1} is the load interaction factor,

$${γ}_{i , i + 1} = \frac{{σ}_{i}}{{σ}_{i + 1}} ;$$

σᵢ is the i-th level stress; n_{i+1,i} is the equivalent cycle number;
the strength degradation model is:

$$R ( n ) = {R}_{0} + ( {R}_{0} - {S}_{f} ) \frac{ln [ 1 - n / ( {N}_{f} + 1 ) ]}{ln ( {N}_{f} + 1 )}$$

wherein R(n) is the residual strength; R₀ is the initial tensile strength; S_{f} is the corresponding stress peak.

Alternatively, the load ratio is combined with the strength degradation coefficient in the form of an exponential function,

$${η}_{i , i + 1} = {( \frac{{σ}_{i}}{{σ}_{i + 1}} )}^{{A}_{k}} ;$$

wherein the strength degradation coefficient is

$${A}_{k} = exp [ \frac{R ( {n}_{i} )}{{R}_{0}} - 1 ] .$$

Alternatively, the data conversion unit specifically comprises:
a data obtaining subunit for obtaining the strain-time data; the strain-time data is a strain signal collected by a strain gauge;
a balance adjustment processing subunit for performing balance adjustment on the strain-time data;
a digital filtering subunit for performing digital filtering;
a conversion subunit for converting the filtered strain signal into a stress signal;
a zero drift processing subunit for performing zero drift on stress signals;
an abnormal signals processing subunit for processing abnormal signals;
a stress signal calculation subunit for calculating the stress signal using the rainflow counting method to obtain a stress spectrum of the strain-time data.

According to the specific embodiments provided by the invention, the invention discloses the following technical effects.

(1) The invention modifies the nonlinear cumulative damage model by introducing stress ratio and strength degradation coefficient. The function is mainly expressed in exponential form, which can better reflect the degradation performance of the material. The model form is simple and does not require the introduction of additional physical parameters. It can be well applied to practical engineering.

(2) In the invention, the strength degradation effect is considered, and the prediction results of fatigue life under multi-level load loading are also relatively accurate, which greatly improves the accuracy of structural fatigue life prediction.

### BRIEF DESCRIPTION OF THE DRAWINGS

In order to illustrate the technical solution of the invention or the prior art more clearly, the drawings used in the embodiments or the description of the prior art will be briefly introduced hereinafter. It is obvious that the drawings hereinafter are just some of the embodiments of the invention. Those of ordinary skill in the art can obtain other drawings according to these drawings without creative efforts.

FIG. 1 is a flow chart of the structural fatigue life prediction method considering strength degradation effect according to the invention.

FIG. 2 shows the prediction results of the damage value of 35 # steel by different models.

FIG. 3 shows the prediction results of the damage value of 30CrMnSiA steel by different models.

FIG. 4 shows the prediction results of the damage value of Q235 steel by different models.

FIG. 5 is a schematic diagram of the structural fatigue life prediction system considering strength degradation effect according to the invention.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

The purpose of the invention is to provide a structural fatigue life prediction method and system considering strength degradation effect, which greatly improves the accuracy of predicting the fatigue life of the structure by considering the strength degradation effect.

In order to make the above purposes, features and advantages of the invention more obvious and easy to understand, the invention will be further described in detail hereinafter with reference to the accompanying drawings and specific embodiments.

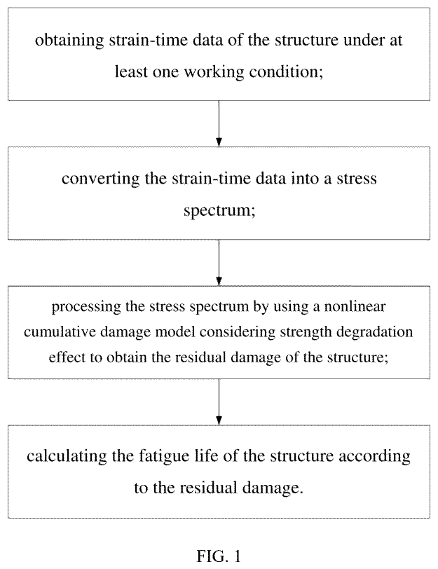

FIG. 1 is a flow chart of the structural fatigue life prediction method considering strength degradation effect according to the invention, and the prediction method specifically includes:
S1: obtaining strain-time data of the structure under at least one working condition;
S2: converting the strain-time data into a stress spectrum;
S3: processing the stress spectrum by using a nonlinear cumulative damage model considering strength degradation effect to obtain the residual damage of the structure;
S4: calculating the fatigue life of the structure according to the residual damage.

To obtain the strain-time data of the structure, it is necessary to determine the fatigue danger zone in combination with the actual operating conditions; conduct dynamic stress test experiments to obtain the stress-time history of the fatigue danger zone under multiple actual operating cycles.

The specific contents of the strain-time data obtaining experiment comprise:
test vehicle: one of the bodies of a locomotive with a long operating time.

Test route: Shenmu to Shenchi South.

Loading conditions: sandbags are placed in the vehicle to simulate the working condition of a heavy vehicle.

Test speed: the test is carried out at the night window debugging point, and the train stops at the station in normal operation without opening and closing the doors.

The stress test points are selected as follows: 1) areas where stress concentration can be estimated, such as areas where the structural shape changes suddenly and weld areas; 2) areas where high stress is estimated based on strength calculation results; 3) areas that require attention in terms of welding and processing.

### Test Process

The stress on the vehicle body chassis is collected using a 32-channel dynamic synchronous acquisition device with a sampling frequency of 500 Hz.

1. The paint on the chassis will affect the stress data collection; when pasting the strain gauge, it needs to be dissolved with paint solvent.

2. In order to make the metal surface smooth, rub the metal surface with gauze, and then use acetone solution to remove the dirt on the metal surface.

3. Apply 502 glue on the strain gauge so that it can be well adhered to the chassis of the vehicle body, and then remove the bubbles on the strain gauge so that it is completely adhered to the chassis of the vehicle body.

4. Apply AB glue strain gauge, and cure and moisture-proof the strain gauge.

5. Use sandbags to simulate the load, and connect the test facilities and circuits.

6. Measure the stress-time data of the vehicle body during normal operation.

Dynamic stress testing has the characteristics of complex testing, large test signal capacity, and long test cycle. The data collection process and scientific data processing directly affect the accuracy of stress spectrum compilation and the results of predicting the fatigue life of the vehicle body.

Download the raw data collected by the equipment to the computer, check whether the information of each channel of the raw data collected this time is normal, and determine the start and end time of the valid data segment in the collected data in combination with the actual operation table of the operating vehicle, extract the valid data and perform zero adjustment processing; check the waveform of each channel in the collected data this time to determine whether there is a zero drift phenomenon, and remove the zero drift of the data with zero drift; filter the noise interference caused by the test environment or equipment operation; convert the original strain signal into a stress signal according to the conversion formula between stress and strain signals; check whether the converted stress signal has burrs in the time domain and frequency domain respectively, remove the burrs of the data with burrs, and finally compile the stress spectrum.

The stress spectra of each measuring point of the vehicle body are shown in Table 1 below.

TABLE 1
Stress Spectrum of Measuring Points

| Measuring | | |
|---|---|---|
| Point | Amplitude | Frequency |
| Numbers | (Sr/Mpa) | (n) |
| Measuring | 0.863798 | 3.33E+05 |
| Point 1 | 2.5914 | 899 |
| | 4.31899 | 10 |
| | 6.04659 | 5 |
| | 7.77419 | 10 |
| | 9.50178 | 4 |
| | 11.2294 | 1 |
| | 12.957 | 2 |
| Measuring | 0.645343 | 8.98E+05 |
| Point 2 | 1.93603 | 8.64E+04 |
| | 3.22671 | 4766 |
| | 4.5174 | 321 |
| | 5.80808 | 39 |
| | 7.09877 | 11 |
| | 8.38946 | 2 |
| | 9.68014 | 2 |
| Measuring | 0.634045 | 3.24E+05 |
| Point 3 | 1.90214 | 1212 |
| | 3.17023 | 35 |
| | 4.43832 | 15 |
| | 5.70641 | 3 |
| | 6.9745 | 1 |
| | 8.24259 | 0 |
| | 9.51068 | 1 |
| Measuring | 2.26703 | 1.00E+06 |
| Point 4 | 6.8011 | 2192 |
| | 11.3352 | 15 |
| | 15.8692 | 6 |
| | 20.4033 | 8 |
| | 24.9374 | 1 |
| | 29.4714 | 2 |
| | 34.0055 | 2 |
| Measuring | 2.13423 | 9.93E+05 |
| Point 5 | 6.4027 | 8261 |
| | 10.6712 | 20 |
| | 14.9396 | 8 |
| | 19.2081 | 6 |
| | 23.4766 | 3 |
| | 27.7451 | 2 |
| | 32.0135 | 2 |
| Measuring | 1.06616 | 1.01E+06 |
| Point 6 | 3.19848 | 1.64E+04 |
| | 5.3308 | 32 |
| | 7.46312 | 7 |
| | 9.59544 | 8 |
| | 11.7278 | 2 |
| | 13.8601 | 1 |
| | 15.9924 | 1 |
| Measuring | 0.111975 | 4.12E+05 |
| Point 7 | 0.335925 | 1312 |
| | 0.559875 | 43 |
| | 0.783825 | 10 |
| | 1.00778 | 4 |
| | 1.23173 | 1 |
| | 1.45568 | 0 |
| | 1.67963 | 1 |

By using the nonlinear cumulative damage model considering the strength degradation effect constructed by the invention to calculate the stress spectrum of each measuring point of the vehicle body, the cumulative damage and fatigue life of the vehicle body structure can be obtained.

For the nonlinear cumulative damage model considering the strength degradation effect, the construction process is as follows:

Construct a nonlinear cumulative damage model for the vehicle body material to be predicted:

$${D}_{i} = {( 1 - \frac{{n}_{i}}{{N}_{fi}} )}^{{δ}_{i}} - 1 = {[ {( 1 - \frac{{n}_{i + 1 , i}}{{N}_{f , ( i + 1 )}} )}^{{δ}_{i + 1}} - 1 ]}^{{γ}_{i , i + 1}} \qquad ( 1 )$$

wherein Dᵢ is the damage of the structure under the i-th level load; N_{fi} is the fatigue life at the corresponding stress level; nᵢ is the number of cycles under the i-th stress level; γ_{i,i+1} is the load interaction factor,

$${γ}_{i , i + 1} = \frac{{σ}_{i}}{{σ}_{i + 1}} ;$$

σᵢ is the i-th level stress; n_{i+1,i} is the equivalent cycle number; δᵢ is the model parameter, which is a model parameter that depends only on N_{f} and the given stress level:

$${δ}_{i} = - 1 \text{.25} / ln {N}_{f i} \qquad ( 2 )$$

Assuming that at this time, a stress of magnitude σ₁ acts on the structure and cycles n₁ times, resulting in fatigue accumulated damage D₁. Before the two-stage loading, the structure has been damaged by the first-stage loading. According to the equivalent principle, the damage D₁ can be expressed as the damage D₂ caused by the stress of magnitude σ₂ cycling n₂₁ times.

$${D}_{1} = {( 1 - \frac{{n}_{1}}{{N}_{f 1}} )}^{{δ}_{1}} - 1 = {[ {( 1 - \frac{{n}_{2 , 1}}{{N}_{f , 2}} )}^{{δ}_{2}} - 1 ]}^{{γ}_{1 , 2}} \qquad ( 3 )$$

At this point, the residual damage of the model under the two-level load can be obtained:

$$\frac{{n}_{2 , res}}{{N}_{f 2}} = {\{ {[ {( 1 - \frac{η}{{N}_{f 1}} )}^{{δ}_{1}} - 1 ]}^{{γ}_{2 , 1}} + 1 \}}^{\frac{1}{{δ}_{2}}} \qquad ( 4 )$$

the fatigue cumulative damage of the structure under two-level loads is:

$$\frac{{n}_{2 , 1}}{{N}_{f 2}} + \frac{{n}_{2}}{{N}_{f 2}} ,$$

then the cumulative fatigue damage of the structure under multi-level loads is

$${C}_{i - 1} = \frac{{n}_{i - 1 , i}}{{N}_{f , ( i - 1 )}} + \frac{{n}_{i - 1}}{{N}_{f , ( i - 1 )}} .$$

the residual damage under multi-level loading is:

$$\frac{{n}_{i , res}}{{N}_{fi}} = {\{ {[ {( 1 - {C}_{i - 1} )}^{{δ}_{i - 1}} - 1 ]}^{{γ}_{i , i - 1}} + 1 \}}^{\frac{1}{{δ}_{i}}} \qquad ( 5 )$$

construct the strength degradation model of the vehicle body material to be predicted:

$$R ( n ) = {R}_{0} + ( {R}_{0} - {S}_{f} ) \frac{ln [ 1 - n / ( {N}_{f} + 1 ) ]}{ln ( {N}_{f} + 1 )} \qquad ( 6 )$$

wherein R(n) is the residual strength; R₀ is the initial tensile strength; S_{f} is the corresponding stress peak.

Assuming that at this time, a stress of magnitude σ₁ acts on the structure and cycles n₁ times, resulting in fatigue accumulated damage R₁. Before the two-stage loading, the strength of the structure has been reduced due to the first-stage loading. According to the equivalent principle, the strength reduction of R₁ can be expressed by the strength reduction R₂ after n₂₁ cycles of stress with σ₂ magnitude.

$${R}_{1} = {R}_{2} \qquad ( 7 )$$

then the equivalent cycle number n₂₁ is:

$${n}_{21} = ( {N}_{2 , f} + 1 ) [ 1 - {e}^{( \frac{{R}_{0} - {σ}_{1}}{{R}_{0} - {σ}_{2}} ) \frac{ln ( {N}_{2 , f} + 1 )}{ln ( {N}_{1 , f} + 1 )} ln ( 1 \frac{{n}_{1}}{{N}_{1 , f + 1}} )} ] \qquad ( 8 )$$

similarly, when a material is subjected to multiple loads until it is finally destroyed,

$${n}_{i , i - 1} = ( {N}_{i , f} + 1 ) [ 1 - {e}^{( \frac{{R}_{0 -} {σ}_{i - 1} \}}{{R}_{0} - {σ}_{i}} ) \frac{ln ( {N}_{i , f} + 1 )}{ln ( {N}_{i - 1 , f} + 1 )} ln ( 1 \frac{{n}_{i - 1}}{{N}_{i - 1 , f + 1}} )} ] \qquad ( 9 )$$

$$R ( {n}_{i} ) = {R}_{0} + ( {R}_{0} - {σ}_{i} ) \frac{ln [ 1 - ( {n}_{i , i - 1} + {n}_{i} ) / ( {N}_{i , f} ) ]}{ln ( {N}_{i , f} + 1 )} \qquad ( 10 )$$

in order to reflect the influence of strength degradation on cumulative damage, the strength degradation coefficient is introduced:

$${A}_{k} = exp [ \frac{R ( {n}_{i} )}{{R}_{0}} - 1 ] \qquad ( 11 )$$

since the model does not consider the strength degradation effect, the load ratio and the strength degradation coefficient are combined in the form of an exponential function:

$${η}_{i , i + 1} + = {( \frac{{σ}_{i}}{{σ}_{i + 1}} )}^{{A}_{k}} \qquad ( 12 )$$

substituting equation (12) into equation (1) yields a new equivalent damage model:

$${D}_{i} = {( 1 - \frac{{n}_{i}}{{N}_{fi}} )}^{{δ}_{i}} - 1 = {[ {( 1 - \frac{{n}_{i + 1 , eq}}{{N}_{f , ( i + 1 )}} )}^{{δ}_{i + 1}} - 1 ]}^{{η}_{i , i + 1}} \qquad ( 13 )$$

the residual damage of the model under the two-level load is obtained:

$$\frac{{n}_{2 , res}}{{N}_{f 2}} = {\{ {[ {( 1 - \frac{{n}_{1}}{{N}_{f 1}} )}^{{δ}_{1}} - 1 ]}^{{η}_{2 , 1}} + 1 \}}^{\frac{1}{{δ}_{2}}} \qquad ( 14 )$$

the residual damage under multi-level loading is:

$$\frac{{n}_{i , res}}{{N}_{fi}} = {\{ {[ {( 1 - {C}_{i - 1} )}^{{δ}_{i - 1}} - 1 ]}^{{η}_{i , i - 1}} + 1 \}}^{\frac{1}{{δ}_{i}}} \qquad ( 15 )$$

formula (13) is a nonlinear fatigue cumulative damage model after considering the correction of residual strength degradation. The model is modified by introducing stress ratio and strength degradation coefficient. The function is mainly expressed in exponential form, which can better reflect the degradation performance of the material. The model form is simple and does not require the introduction of additional physical parameters. The prediction results of fatigue life under multi-level load loading are also relatively accurate.

In order to verify the accuracy of the nonlinear cumulative damage model considering strength degradation effect of the invention, the invention verifies the model through existing metal material fatigue test data.

Through data search, the second, fourth, and sixth level fatigue test data of some metal materials are selected for verification. In order to better demonstrate the advantages of the proposed model in life prediction, an error factor E is introduced to describe the prediction error of the four models, as shown in formula (16). Specifically, the mean M and standard deviation S of E represent the “accuracy” and “reliability” of the model prediction, respectively. The smaller the mean and standard deviation and the closer they are to 0, the more accurate and reliable the prediction, and vice versa.

$$E = \vert \frac{{( \frac{n}{{N}_{f}} )}_{exp} - {( \frac{n}{{N}_{f}} )}_{pre}}{{( \frac{n}{{N}_{f}} )}_{exp}} \vert \qquad ( 16 )$$

In the formula,

$${( \frac{n}{{N}_{f}} )}_{exp}$$

is the test cycle ratio;

$${( \frac{n}{{N}_{f}} )}_{pre}$$

is the predicted cycle ratio.

### (1) Comparative Analysis of Fatigue Life Prediction Results of 35 # Steel

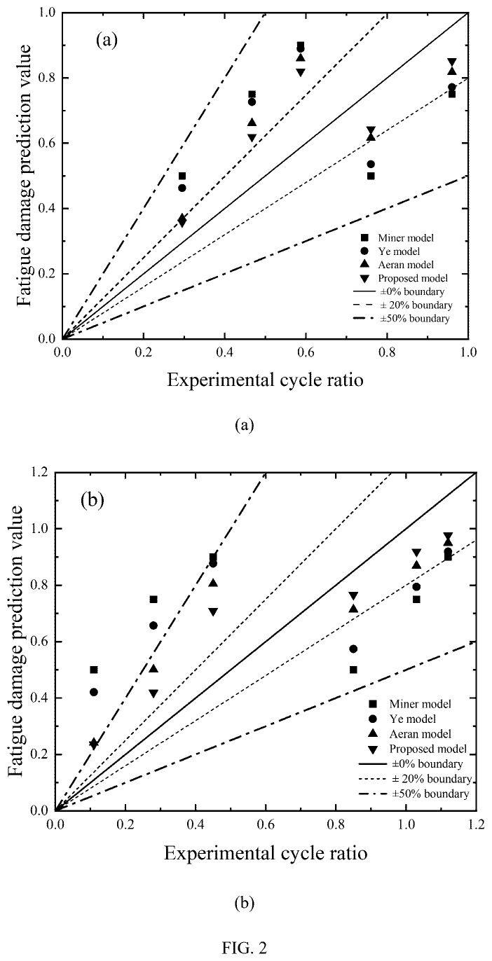

35 # steel has good strength, plasticity and toughness. It is widely used in various fields such as machinery, automobiles, construction and ships. It is a high-quality carbon structural steel. When the loading stress amplitude of C35 steel is 353 MPa, 334 MPa, 294 MPa and 275 MPa, its fatigue life is 52000, 110000, 400000 and 760000 times respectively. Its tensile strength is 458 MPa. Taking the two-stage loading test of 35 # steel in the literature as an example, the fatigue life of Miner, Ye and modified nonlinear cumulative damage models are predicted respectively. The results and error values of the predicted values and test values are shown in Table 2. The error values of the four models are then averaged and the standard deviation is calculated, and the results are shown in Table 3. The comparison between the predicted value and the experimental value of the final fatigue life is shown in FIG. 2, where FIG. 2 (a) is 334-294 MPa vs. 294-334 MPa, and FIG. 2 (b) is 353-275 MPa vs. 275-353 MPa.

TABLE 2
Fatigue Test Data of 35# steel Specimens Under Two-Level
Loading and Fatigue Life Prediction Values of Each Model

| | | | | | | | Modified | | | |
|---|---|---|---|---|---|---|---|---|---|---|
| | Test Data | | | | | | Nonlinear | | | |
| Loading | Measured | | | | | | Cumulative | | Model of This | |
| Stress/ | Value | | Mine Model | | Ye Model | | Damage Model | | Chapter | |
| MPa | n₁/N₁ | n₂/N₂ | n₂/N₂ | δ/% | n₂/N₂ | δ/% | n₂/N₂ | δ/% | n₂/N₂ | δ/% |
| 334-294 | 0.1 | 0.587 | 0.9 | 53.32 | 0.889 | 51.53 | 0.859 | 46.47 | 0.819 | 39.61 |
| | 0.25 | 0.467 | 0.75 | 60.59 | 0.726 | 55.54 | 0.661 | 41.73 | 0.619 | 32.67 |
| | 0.5 | 0.295 | 0.5 | 69.49 | 0.462 | 56.91 | 0.370 | 25.45 | 0.357 | 21.22 |
| 294-334 | 0.1 | 1.06 | 0.9 | 15.09 | 0.909 | 14.19 | 0.929 | 12.33 | 0.950 | 10.35 |
| | 0.25 | 0.96 | 0.75 | 21.87 | 0.771 | 19.59 | 0.818 | 14.77 | 0.851 | 11.31 |
| | 0.5 | 0.76 | 0.5 | 34.21 | 0.535 | 29.48 | 0.616 | 18.85 | 0.643 | 15.38 |
| 353-275 | 0.1 | 0.45 | 0.9 | 96.51 | 0.877 | 91.46 | 0.805 | 75.76 | 0.709 | 54.83 |
| | 0.25 | 0.28 | 0.75 | 166.9 | 0.657 | 133.88 | 0.501 | 78.29 | 0.419 | 49.29 |
| | 0.5 | 0.11 | 0.5 | 358.72 | 0.421 | 286.51 | 0.241 | 121.1 | 0.235 | 115.87 |
| 275-353 | 0.1 | 1.12 | 0.9 | 19.64 | 0.919 | 17.95 | 0.95 | 15.18 | 0.977 | 12.74 |
| | 0.25 | 1.03 | 0.75 | 27.18 | 0.794 | 22.91 | 0.869 | 15.63 | 0.919 | 10.76 |
| | 0.5 | 0.85 | 0.5 | 41.18 | 0.574 | 32.52 | 0.714 | 16 | 0.766 | 9.85 |

TABLE 3
Prediction Error Statistics of 35# steel
Specimens Under Two-Level Loading

| | | | | Modified | |
|---|---|---|---|---|---|
| | | | | Nonlinear | |
| | | | | Cumulative | Model of |
| | | Miner | | Damage | This |
| Material | | Model | Ye Model | Model | Chapter |
| 35 Steel | M | 80.39% | 67.71% | 32.47% | 25.82% |
| | S | 97.39% | 77.29% | 42.52% | 36.68% |

As can be seen from FIG. 2, 41.67% of the prediction results of the model in this chapter are within the 20% error band and closer to the 0% error band, while the other three models only correct the nonlinear cumulative damage model part of the prediction results within the 20% error band, and all the prediction results of the Miner model are within the 50% error band. This means that the prediction results of the model of the invention for 35 # steel are better than those of the other models.

### (2) Comparative Analysis of Fatigue Life Prediction Results of 30CrMnSiA Steel

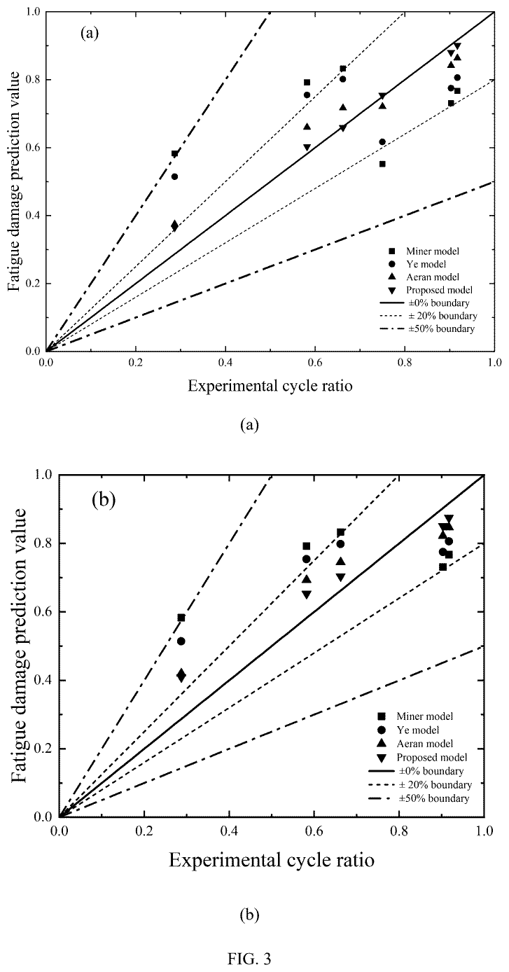

30CrMnSiA is an ultra-high strength alloy structural steel, commonly used in the manufacture of aircraft engine frames, engine compressor blades, etc. When the loading stress amplitude of 30CrMnSiA steel is 586 MPa, 482 MPa, 732 MPa, and 836 MPa, its fatigue life is 52000, 760000, 55793, and 7186 times, respectively. Taking the two-stage loading test of 30CrMnSiA in the literature as an example, the fatigue life of the four models is predicted respectively, and the results and error values of the predicted values and experimental values are shown in Table 4. The error values of the four models are then calculated by the mean and standard deviation, and the results are shown in Table 5. Finally, the comparison of the predicted value and experimental value of fatigue life is shown in FIG. 3, where FIG. 3 (a) is 586-482 MPa and 482-586 MPa, and FIG. 3 (b) is 836-732 MPa and 732-836 MPa.

TABLE 4
Fatigue Test Data of 30CrMnSiA Under Two-Level Loading
and Fatigue Life Prediction Values of Each Model

| | | | | | | | Modified | | | |
|---|---|---|---|---|---|---|---|---|---|---|
| | | | | | | | Nonlinear | | | |
| | Test Data | | | | | | Cumulative | | | |
| Loading | Measured | | | | | | Damage | | Model of | |
| Stress/ | Value | | Miner Model | | Ye Model | | Model | | This Chapter | |
| MPa | n₁/N₁ | n₂/N₂ | n₂/N₂ | δ/% | n₂/N₂ | δ/% | n₂/N₂ | δ/% | n₂/N₂ | δ/% |
| 586-482 | 0.167 | 0.662 | 0.833 | 25.83 | 0.801 | 21.09 | 0.717 | 0.83 | 0.659 | 0.45 |
| | 0.208 | 0.582 | 0.792 | 36.08 | 0.754 | 29.71 | 0.66 | 13.4 | 0.603 | 3.63 |
| | 0.417 | 0.287 | 0.583 | 103.1 | 0.514 | 79.37 | 0.375 | 30.66 | 0.364 | 27.04 |
| 482-586 | 0.233 | 0.917 | 0.767 | 16.36 | 0.806 | 12.09 | 0.864 | 5.78 | 0.901 | 1.70 |
| | 0.269 | 0.903 | 0.731 | 19.05 | 0.775 | 14.16 | 0.842 | 6.76 | 0.880 | 2.53 |
| | 0.448 | 0.75 | 0.552 | 26.4 | 0.617 | 17.73 | 0.721 | 3.86 | 0.754 | 0.59 |

TABLE 5
Prediction Error Statistics of 30CrMnSiA
Under Two-Level Loading

| | | | | Modified | |
|---|---|---|---|---|---|
| | | | | Nonlinear | |
| | | | | Cumulative | Model of |
| | | Miner | | Damage | This |
| Material | | Model | Ye Model | Model | Chapter |
| 30CrMnSiA | M | 37.8% | 29.03% | 10.22% | 5.99% |
| | S | 32.71% | 25.42% | 10.85% | 10.38% |

It can be seen from Table 4, Table 5 and FIG. 3 that the prediction results of the corrected nonlinear cumulative damage and the proposed model for 30CrMnSiA are relatively good, with mean errors of 14.09% and 9.31% compared with the experimental values, while the mean error of the Miner and Ye models compared with the experimental values is about 30%.

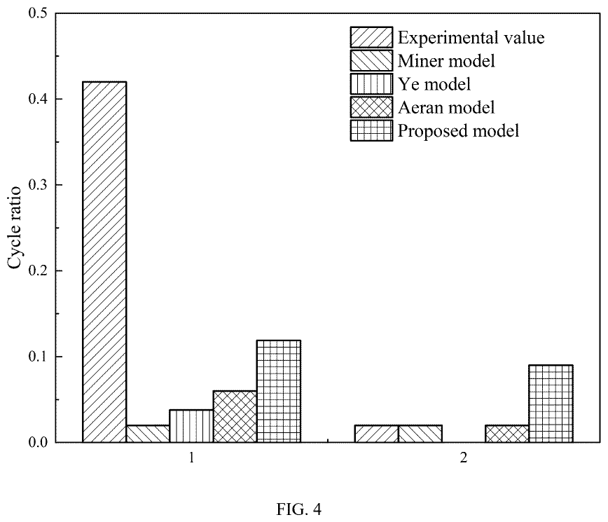

Q235B is a commonly used welding material for vehicle bogie welded frames. Taking the four-level loading test of Q235B in the literature as an example, the fatigue life of four models is predicted respectively. The results and error values of the predicted values and experimental values are shown in Table 6. The comparison of the predicted value and experimental value of fatigue life is shown in FIG. 4.

TABLE 6
Fatigue Data of Q235 Under Four-Level Loading and Fatigue Life Prediction Values of Each Model

| | | | | | Damage Ratio | | | | | | | |
|---|---|---|---|---|---|---|---|---|---|---|---|---|
| | | | | | | | | | Modified | | | |
| | | | | | | | | | Nonlinear | | | |
| | | | | | | | | | Cumulative | | | |
| | Loading | | | | | | | | Damage | | Model of | |
| Stress | Stress/ | Test Data | | | Miner Model | | Ye Model | | Model | | This Chapter | |
| Level | MPa | nᵢ | Nᵢ | nᵢ/Nᵢ | N₄/N₄ | δ/% | N₄/N₄ | δ/% | N₄/N₄ | δ/% | N₄/N₄ | δ/% |
| 1 | 20.6 | 496000 | 1797700 | 0.28 | 0.02 | 95.24 | 0.038 | 90.95 | 0.06 | 85.71 | 0.119 | 71.59 |
| 2 | 21.5 | 503000 | 1441500 | 0.35 | | | | | | | | |
| 3 | 22.4 | 406000 | 1166400 | 0.35 | | | | | | | | |
| 4 | 23.3 | 399400 | 951700 | 0.42 | | | | | | | | |
| 1 | 28.95 | 400000 | 1464700 | 0.27 | 0.02 | 83.33 | 0 | 0.00 | 0.02 | 83.33 | 0.090 | 24.25 |
| 2 | 31.48 | 400000 | 1190200 | 0.34 | | | | | | | | |
| 3 | 32.00 | 400000 | 97700 | 0.41 | | | | | | | | |
| 4 | 35.05 | 82400 | 676200 | 0.12 | | | | | | | | |

It can be seen from Table 6 and FIG. 4 that the prediction accuracy of the proposed model for Q235 is greatly improved compared with other models, and the Ye model is unable to predict.

41Cr4 is the most commonly used alloy structural steel with high tensile strength, yield strength and hardenability. It is often used for quenched and tempered parts under alternating load, medium speed and medium load, such as gears, sleeves, shafts, crankshafts and pins. Taking the six-level loading test of 41Cr4 in the literature as an example, the fatigue life of four models is predicted respectively. The results and error values of the predicted values and test values are shown in Table 7.

TABLE 7
Fatigue Data of 41Cr4 Under Six-Level Loading and Fatigue Life Prediction
Values of Each Model

| | | | | | Damage Ratio | | | | | | | |
|---|---|---|---|---|---|---|---|---|---|---|---|---|
| | | | | | | | | | Modified | | | |
| | | | | | | | | | Nonlinear | | | |
| | | | | | | | | | Cumulative | | Model of | |
| | Loading | | | | Miner | | | | Damage | | This | |
| Stress | Stress/ | Test Data | | | Model | | Ye Model | | Model | | Chapter | |
| Level | MPa | nᵢ | Nᵢ | nᵢ/Nᵢ | n₄/N₄ | δ/% | n₄/N₄ | δ/% | n₄/N₄ | δ/% | n₄/N₄ | δ/% |
| 1 | 505 | 4 | 9000 | 0.004 | 0.596 | 130.92 | 0.534 | 152.86 | 0.397 | 87.71 | 0.183 | 13.28 |
| 2 | 475 | 32 | 11600 | 0.03 | | | | | | | | |
| 3 | 423 | 560 | 21000 | 0.027 | | | | | | | | |
| 4 | 362 | 5440 | 47000 | 0.116 | | | | | | | | |
| 5 | 387 | 40000 | 155000 | 0.258 | | | | | | | | |
| 6 | 212 | 184000 | 870000 | 0.212 | | | | | | | | |

The S-N curve and the cumulative damage model are both indispensable in calculating the fatigue life of the vehicle body. In order to clarify the S-N curve of the vehicle body material, this technical solution introduces the 7608 standard, which can obtain its S-N curve by checking the weld grade, structural form, etc.

Table 8 shows the damage comparison table of the nonlinear cumulative damage model considering strength degradation, the nonlinear cumulative damage model and the linear cumulative damage model. It can be seen from Table 8 that the damage of each measuring point is from small to large, which is the model of this technical solution, the nonlinear cumulative damage model, and the Miner linear cumulative damage model, indicating that the linear cumulative damage model is more conservative than the nonlinear cumulative damage model; but the three models keep the same trend in damage prediction.

TABLE 8
Damage Prediction Values of Three Models

| Measuring | | | |
|---|---|---|---|
| Point | | Nonlinear Cumulative | Model of This |
| Number | Miner Model | Model | Chapter |
| 1 | 8.93 × 10⁻⁹ | 8.59 × 10⁻⁹ | 8.08 × 10⁻⁹ |
| 2 | 2.66 × 10⁻⁸ | 1.78 × 10⁻⁸ | 3.14 × 10⁻⁹ |
| 3 | 4.75 × 10⁻¹² | 1.67 × 10⁻¹² | 8.63 × 10⁻¹³ |
| 4 | 9.46 × 10⁻⁷ | 8.45 × 10⁻⁷ | 7.22 × 10⁻⁸ |
| 5 | 2.77 × 10⁻⁶ | 8.88 × 10⁻⁷ | 2.39 × 10⁻⁷ |
| 6 | 7.42 × 10⁻⁷ | 1.22 × 10⁻⁷ | 2.07 × 10⁻⁸ |
| 7 | 1.20 × 10⁻¹³ | 9.79 × 10⁻¹⁴ | 8.05 × 10⁻¹⁴ |

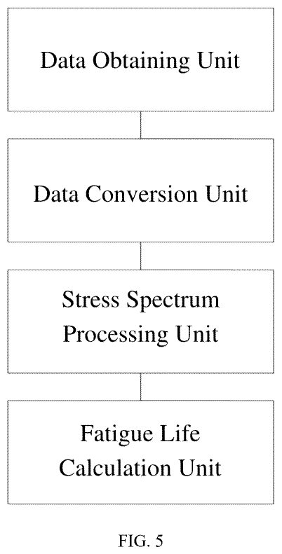

FIG. 5 is a schematic diagram of a structural fatigue life prediction system considering strength degradation effect according to the invention. The structural fatigue life prediction method considering strength degradation effect according to the invention can be implemented. The prediction system comprises: a data obtaining unit, a data conversion unit, a stress spectrum processing unit and a fatigue life calculation unit.

The data obtaining unit is used for obtaining strain-time data of the structure under at least one working condition.

The data conversion unit is used for converting the strain-time data into a stress spectrum.

The stress spectrum processing unit is used for processing the stress spectrum by using a nonlinear cumulative damage model considering strength degradation effect to obtain the residual damage of the structure.

The fatigue life calculation unit is used for calculating the fatigue life of the structure according to the residual damage.

The data conversion unit specifically comprises: a data obtaining subunit, a data obtaining subunit, a data obtaining subunit, a conversion subunit, a zero drift processing subunit, an abnormal signals processing subunit, and a stress signal calculation subunit.

The data obtaining subunit is used for obtaining the strain-time data; the strain-time data is a strain signal collected by a strain gauge.

The balance adjustment processing subunit is used for performing balance adjustment on the strain-time data.

The digital filtering subunit is used for performing digital filtering.

The conversion subunit is used for converting the filtered strain signal into a stress signal.

The zero drift processing subunit is used for performing zero drift on stress signals.

The abnormal signals processing subunit is used for processing abnormal signals.

The stress signal calculation subunit is used for calculating the stress signal using the rainflow counting method to obtain a stress spectrum of the strain-time data.

The prediction system further comprises a model building unit, specifically comprising: a model obtaining subunit, a strength degradation coefficient introduction subunit, and a model updating subunit.

The model obtaining subunit is used for obtaining nonlinear cumulative damage model and strength degradation model considering history loading effect.

The strength degradation coefficient introduction subunit is used for introducing a strength degradation coefficient according to the strength degradation model.

The model updating subunit is used for updating the nonlinear cumulative damage model by using the load ratio and the strength degradation coefficient to obtain a nonlinear cumulative damage model considering strength degradation effect.

The nonlinear cumulative damage model is:

$${D}_{i} = {( 1 - \frac{{n}_{i}}{{N}_{fi}} )}^{{δ}_{i}} - 1 = {[ {( 1 - \frac{{n}_{i + 1 i}}{{N}_{f ( i + 1 )}} )}^{{δ}_{i + 1}} - 1 ]}^{{γ}_{i , i + 1}}$$

wherein Dᵢ is the damage of the structure under the i-th load level; N_{fi} is the fatigue life at the corresponding stress level; nᵢ is the number of cycles under the i-th stress level; δᵢ is a model parameter that depends only on N_{f} and the given stress level, δᵢ=−1.25/ln N_{fi}; γ_{i,i+1} is the load interaction factor,

$${γ}_{i , i + 1} = \frac{{σ}_{i}}{{σ}_{i + 1}} ;$$

σᵢ is the i-th level stress; n_{i=1,i} is the equivalent cycle number;
the strength degradation model is:

$$R ( n ) = {R}_{0} + ( {R}_{0} - {S}_{f} ) \frac{ln [ 1 - n / ( {N}_{f} + 1 ) ]}{ln ( {N}_{f} + 1 )}$$

wherein R(n) is the residual strength; R₀ is the initial tensile strength; S_{f} is the corresponding stress peak.
the load ratio is combined with the strength degradation coefficient in the form of an exponential function,

$${η}_{i , i + 1} = {( \frac{{σ}_{i}}{{σ}_{i + 1}} )}^{{A}_{k}} ;$$

wherein the strength degradation coefficient is

$${A}_{k} = exp [ \frac{R ( {n}_{i} )}{{R}_{0}} - 1 ] .$$

In this specification, each embodiment is described in a progressive manner, and each embodiment focuses on the differences from other embodiments. The same or similar parts between the embodiments can be referred to each other. For the system disclosed in the embodiment, since it corresponds to the method disclosed in the embodiment, the description is relatively simple, and the relevant parts can be referred to the method part.

This article uses specific embodiments to illustrate the principles and implementation methods of the invention. The above embodiments are only used to help understand the method and core ideas of the invention. At the same time, for those skilled in the art, according to the ideas of the invention, there will be changes in the specific implementation methods and application scope. In summary, the content of this specification should not be understood as limiting the invention.

1. A structural fatigue life prediction method considering strength degradation effect, wherein the method includes:
obtaining strain-time data of the structure under at least one working condition;
converting the strain-time data into a stress spectrum;
processing the stress spectrum by using a nonlinear cumulative damage model considering strength degradation effect to obtain the residual damage of the structure;
calculating the fatigue life of the structure according to the residual damage.

2. The structural fatigue life prediction method considering strength degradation effect of claim 1, wherein the method further includes: constructing a nonlinear cumulative damage model considering strength degradation effect, specifically including:
obtaining nonlinear cumulative damage model and strength degradation model considering history loading effect;
introducing a strength degradation coefficient according to the strength degradation model;
updating the nonlinear cumulative damage model by using the load ratio and the strength degradation coefficient to obtain a nonlinear cumulative damage model considering strength degradation effect.

3. The structural fatigue life prediction method considering strength degradation effect of claim 2, wherein the nonlinear cumulative damage model is:
$${D}_{i} = {( 1 - \frac{{n}_{i}}{{N}_{fi}} )}^{{δ}_{i}} - 1 = {[ {( 1 - \frac{{n}_{i + 1 , i}}{{N}_{f , ( i + 1 )}} )}^{{δ}_{i + 1}} - 1 ]}^{{γ}_{i , i + 1}}$$
wherein Dᵢ is the damage of the structure under the i-th level load; N_{fi} is the fatigue life at the corresponding stress level; nᵢ is the number of cycles under the i-th stress level; δᵢ is the model parameter, which is a model parameter that depends only on N_{f} and the given stress level, δᵢ=−1.25/ln N_{fi}; γ_{i,i+1} is the load interaction factor,
$${γ}_{i , i + 1} = \frac{{σ}_{i}}{{σ}_{i + 1}} ;$$
σᵢ is the i-th level stress; n_{i+1,i} is the equivalent cycle number;
the strength degradation model is:
$$R ( n ) = {R}_{0} + ( {R}_{0} - {S}_{f} ) \frac{ln [ 1 - n / ( {N}_{f} + 1 ) ]}{ln ( {N}_{f} + 1 )}$$
wherein R(n) is the residual strength; R₀ is the initial tensile strength; S_{f} is the corresponding stress peak.

4. The structural fatigue life prediction method considering strength degradation effect of claim 3, wherein the load ratio is combined with the strength degradation coefficient in the form of an exponential function,
$${η}_{i , i + 1} = {( \frac{{σ}_{i}}{{σ}_{i + 1}} )}^{{A}_{k}} ;$$
wherein the strength degradation coefficient is
$${A}_{k} = exp [ \frac{R ( {n}_{i} )}{{R}_{0}} - 1 ] .$$

5. The structural fatigue life prediction method considering strength degradation effect of claim 1, wherein converting the strain-time data into a stress spectrum specifically includes:
obtaining the strain-time data; the strain-time data is a strain signal collected by a strain gauge;
performing balance adjustment on the strain-time data;
performing digital filtering;
converting the filtered strain signal into a stress signal;
performing zero drift on stress signals;
processing abnormal signals;
calculating the stress signal using the rainflow counting method to obtain a stress spectrum of the strain-time data.

6. A structural fatigue life prediction system considering strength degradation effect, wherein the system comprises:
a data obtaining unit for obtaining strain-time data of the structure under at least one working condition;
a data conversion unit for converting the strain-time data into a stress spectrum;
a stress spectrum processing unit for processing the stress spectrum by using a nonlinear cumulative damage model considering strength degradation effect to obtain the residual damage of the structure;
a fatigue life calculation unit for calculating the fatigue life of the structure according to the residual damage.

7. The structural fatigue life prediction system considering strength degradation effect of claim 6, wherein the system further comprises a model building unit, specifically comprising:
a model obtaining subunit for obtaining nonlinear cumulative damage model and strength degradation model considering history loading effect;
a strength degradation coefficient introduction subunit for introducing a strength degradation coefficient according to the strength degradation model;
a model updating subunit for updating the nonlinear cumulative damage model by using the load ratio and the strength degradation coefficient to obtain a nonlinear cumulative damage model considering strength degradation effect.

8. The structural fatigue life prediction system considering strength degradation effect of claim 7, wherein the nonlinear cumulative damage model is:
$${D}_{i} = {( 1 - \frac{{n}_{i}}{{N}_{fi}} )}^{{δ}_{i}} - 1 = {[ {( 1 - \frac{{n}_{i + 1 , i}}{{N}_{f , ( i + 1 )}} )}^{{δ}_{i + 1}} - 1 ]}^{{γ}_{i , i + 1}}$$
wherein Dᵢ is the damage of the structure under the i-th load level; N_{f}, is the fatigue life at the corresponding stress level; nᵢ is the number of cycles under the i-th stress level; δᵢ is a model parameter that depends only on N_{f} and the given stress level, δᵢ=−1.25/ln N_{fi}; γ_{i,i+1} is the load interaction factor,
$${γ}_{i , i + 1} = \frac{{σ}_{i}}{{σ}_{i + 1}} ;$$
σᵢ is the i-th level stress; n_{i+1,i} is the equivalent cycle number;
the strength degradation model is:
$$R ( n ) = {R}_{0} + ( {R}_{0} - {S}_{f} ) \frac{ln [ 1 - n / ( {N}_{f} + 1 ) ]}{ln ( {N}_{f} + 1 )}$$
wherein R(n) is the residual strength; R₀ is the initial tensile strength; S_{f} is the corresponding stress peak.

9. The structural fatigue life prediction system considering strength degradation effect of claim 8, wherein the load ratio is combined with the strength degradation coefficient in the form of an exponential function,
$${η}_{i , i + 1} = {( \frac{{σ}_{i}}{{σ}_{i + 1}} )}^{{A}_{k}} ;$$
wherein the strength degradation coefficient is
$${A}_{k} = exp [ \frac{R ( {n}_{i} )}{{R}_{0}} - 1 ] .$$

10. The structural fatigue life prediction system considering strength degradation effect of claim 6, wherein the data conversion unit specifically comprises:
a data obtaining subunit for obtaining the strain-time data; the strain-time data is a strain signal collected by a strain gauge;
a balance adjustment processing subunit for performing balance adjustment on the strain-time data;
a digital filtering subunit for performing digital filtering;
a conversion subunit for converting the filtered strain signal into a stress signal;
a zero drift processing subunit for performing zero drift on stress signals;
an abnormal signals processing subunit for processing abnormal signals;
a stress signal calculation subunit for calculating the stress signal using the rainflow counting method to obtain a stress spectrum of the strain-time data.
